(19) United States
(12) Patent Application Publication
(10) Pub. No.: US 2019/0002343 A1
(43) Pub. Date: Jan. 3, 2019

(54) METHOD OF FABRICATION OF A LIGHTWEIGHT AGGREGATE AND PRODUCT FORMED FROM PAPER MILL SLUDGE

(71) Applicants: Joshua Wade Hargrove, Mason, TX (US); Zachary Kent Rabon, Mason, TX (US)

(72) Inventors: Joshua Wade Hargrove, Mason, TX (US); Zachary Kent Rabon, Mason, TX (US)

(21) Appl. No.: 15/744,599

(22) PCT Filed: Jul. 13, 2016
(86) PCT No.: PCT/US16/42088

§ 371 Date: Jan. 12, 2018

Related U.S. Application Data
(60) Provisional application No. 62/191,609, filed on Jul. 13, 2015.

(51) Int. Cl. C04B 18/24; C04B 18/02; C04B 14/06

(52) U.S. Cl. CPC C04B 18/243; C04B 2111/40; C04B 14/06; C04B 18/027

(57) ABSTRACT

A lightweight building material is fabricated from paper mill sludge having about 50% water and 50% organic and inorganic materials, by taking the sludge, and drying the material in a super-heated steam bath and treating it with sodium silicate, which can be either powdered or liquid, to a selected end moisture content. Additional processing can be used at varying desired end moisture materials to create unique lightweight building aggregates from this waste source material.

### CROSS REFERENCE TO RELATED APPLICATIONS (IF ANY)

There are no related applications other than the U.S. Provisional from which this application claims priority, U.S. Application No. 62/191,609, filed Jul. 13, 2015.

The present invention relates to a process for making a lightweight aggregate from paper mill sludge; more specifically, for taking wet paper mill sludge, drying and treating it to a particular selected moisture content, to form a lightweight aggregate which can be used in construction.

### STATEMENT OF FEDERALLY SPONSORED RESEARCH OR DEVELOPMENT (IF ANY)

This does not apply.

### THE NAMES OF THE PARTIES TO A JOINT RESEARCH AGREEMENT

This invention was not made under a joint research agreement.

### BACKGROUND OF INVENTION

This application seeks to recover the significant waste product of a paper mill; allowing continued “green” use of such materials for building materials utilizing paper mill sludge. Applicant has previously had success using post-consumer waste paper (newsprint, phonebooks, and lottery tickets) classified as short fiber cellulose in manufacturing building materials and seeks to continue this quest in providing environmentally sound building materials using waste paper products.

It is common practice for paper manufacturers to use a similar feedstock, as well as office documents, as a majority component in their paper making process. The ratio of recycled content (RC) to virgin fiber (VF) that is preferred is 70%-90% RC to 10%-30% VF. After bleaching and pulping the feedstock, the paper making process begins and as a byproduct of the process discharges fibers too small for its paper-making purposes, along with excess water to be treated and dumped. The Residual Short Fiber (RSF) or “sludge” is a byproduct of the waste treatment that is similar in process to that of municipal sewage (in that water and solids are separated and volatile organics are broken down with micro-organisms). The sludge is then solidified (usually for the purpose of disposal) through the use of, all or in part, sedimentation basins and machines such as high velocity thickeners, drum screens, belt presses, and screw presses. The present application seeks to use the solids from this process to create lightweight building aggregates that may then be reused rather than discharged into landfills and the like.

### SUMMARY OF INVENTION

This method for fabrication of lightweight aggregate comprises the steps of: collecting a wet sludge stream from a paper mill containing about 50% moisture and 50% solid sludge materials; depositing the wet sludge stream conveying organic solids of short fiber cellulose, calcium carbonate, ash, and one or more of the following oxides—calcium oxide, aluminum oxide, magnesium oxide, iron oxide, and silicon dioxide—into a drying means; introducing sufficient heat to create a super-heated steam from the 50% moisture content contained in the wet sludge stream; and, removing the solids when a selected end moisture content has been obtained. The drying means can consist of an enclosed conveyor belt drying system; a rotating drum dryer; or a fluid bed dryer, to each of which is applied heat to create a steam blanket and eventually a superheated steam to drive off the moisture from the initial mix.

This method can further comprise a step of spraying sodium silicate on the drying sludge material or coating of dried sodium silicate into the wet sludge to begin a reaction with the available moisture to decrease the moisture content. This powdered sodium silicate is loaded at a rate of between 3-10% of the weight of the solids contained in the wet sludge stream. The heat applied to create the super heated steam is applied and re-circulated through the sludge material for a period of time between 90-240 minutes at a temperature between 150° C. (302° F.) and 300° C. (572° F.) to achieve the desired end moisture content.

The short fiber cellulose at the start of the fabrication process preferably has a fiber length of about 1.1 mm and a specific gravity of about 2.0 carried in the wet sludge containing the cellulose fibers, calcium carbonate, clays, and ash. The desired end moisture of the lightweight aggregate ranges from 5-25%. When the desired end moisture content of 5-15% (or 8-12%, see p. 9, line 25) is acquired the lightweight aggregate can be used in pre-cast concrete. or ready-mixed concrete, as a replacement of traditional sand or gravel in the range of 5-50%, but full replacement of the traditional sand and gravel has yielded successes for non-structural applications.

The calcium carbonate and clay comes from the paper mill feedstock and result from the original paper making process. Most paper mills use multiple sources of raw feedstock. Acid-free, or alkaline paper is coated in a calcium bicarbonate that neutralizes natural acids in wood pulp and lignin. As the freshly made paper dries, water is reduced and carbon dioxide is released, leaving calcium carbonate. Calcium carbonate is used as filler in the base sheet and in the paper coating as a pigment, providing both brightness and a more blue-white shade than clay alone. The clay found in the paper mill wet sludge is something that has multiple sources. It is used as filler in both acidic and alkaline papers, with higher clay content typically occurring in acidic paper. Clays also serve as fillers or extenders in ink, which primarily reduces the cost of pigments. Most paper mills pulp all types of paper together prior to the manufacture of paper products, such as toilet paper and hand towels; in general, both clay and calcium carbonate are striped from the pulp in a screening process prior to the manufacture.

### Ash Content

Ash is an industry term in the paper world resulting from the amount of filler in a paper. Paper consists of organic cellulose fibers combined with inorganic fillers such as clay, titanium dioxide, or calcium carbonate, added during papermaking to increase such paper properties as brightness, whiteness, or opacity. For many printing processes, a filler or ash content of 15-20% may be desirable. To determine the ash content of a paper, a sample is weighed, and then subjected to complete combustion (usually at 925° C., ±25° C.). This removes all the organic constituents of the sample, leaving behind a residue of inorganic materials, or fillers. This is weighed, and the percentage of the original sample that remains is its ash content. Further analytical procedures can determine the chemical makeup of the ash as a means of identifying the specific fillers used. No additional ash is applied to the fabrication process of the lightweight aggregate of the present application.

Preferably, the lightweight aggregate formed resulting from this process has a sieve size range resulting in 99.75% of the material falling between 9.75 mm (⅜ inch) and 0.149 mm (0.0059 inch). When the method is used to manufacture the lightweight aggregate having desired end moisture content of 12-25%, the aggregate can be noodled through a dye in an extrusion process, and sheared to create a consistent size material. After this process, the material can be further dried to achieve moisture content of 5-15% moisture.

This lightweight aggregate can also be used as a replacement of traditional aggregates in a range of 5-50%, or as a full replacement as previously mentioned for non-structural building applications. Prior lightweight aggregate manufacturing processes added additional ash to bulk up the resulting product; Applicant's process does not require this additional ash content.

### DETAILED DESCRIPTION OF DRAWINGS

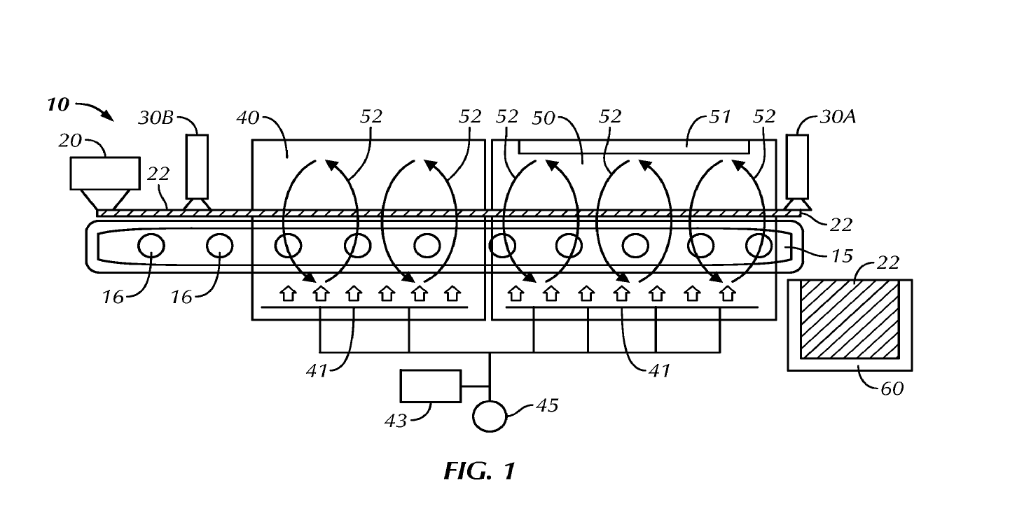

FIG. 1 is a side schematic view of the drying conveyor belt of a preferred embodiment of this lightweight aggregate process.

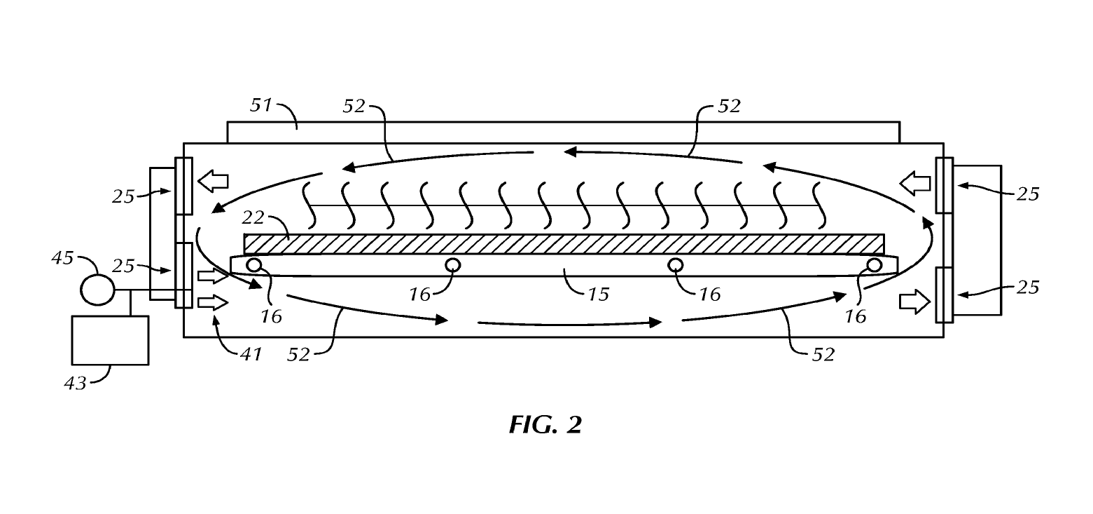

FIG. 2 is an side schematic view of the drying conveyor belt system of a preferred embodiment disclosing the recirculation of steam to achieve superheated steam for the drying process.

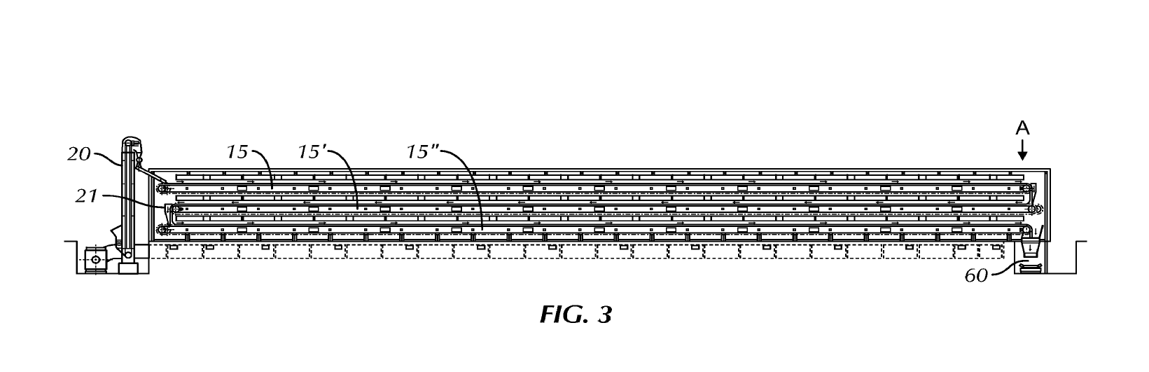

FIG. 3 is a detailed side view of the three tiered enclosed conveyor belt drying system of the present invention.

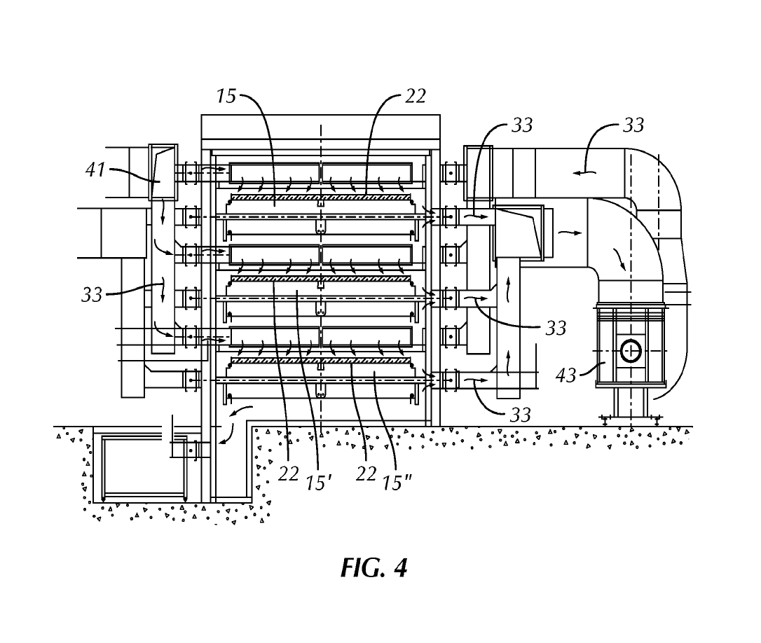

FIG. 4 is a cross-sectional view of the three tiered enclosed conveyor belt drying system of the present invention.

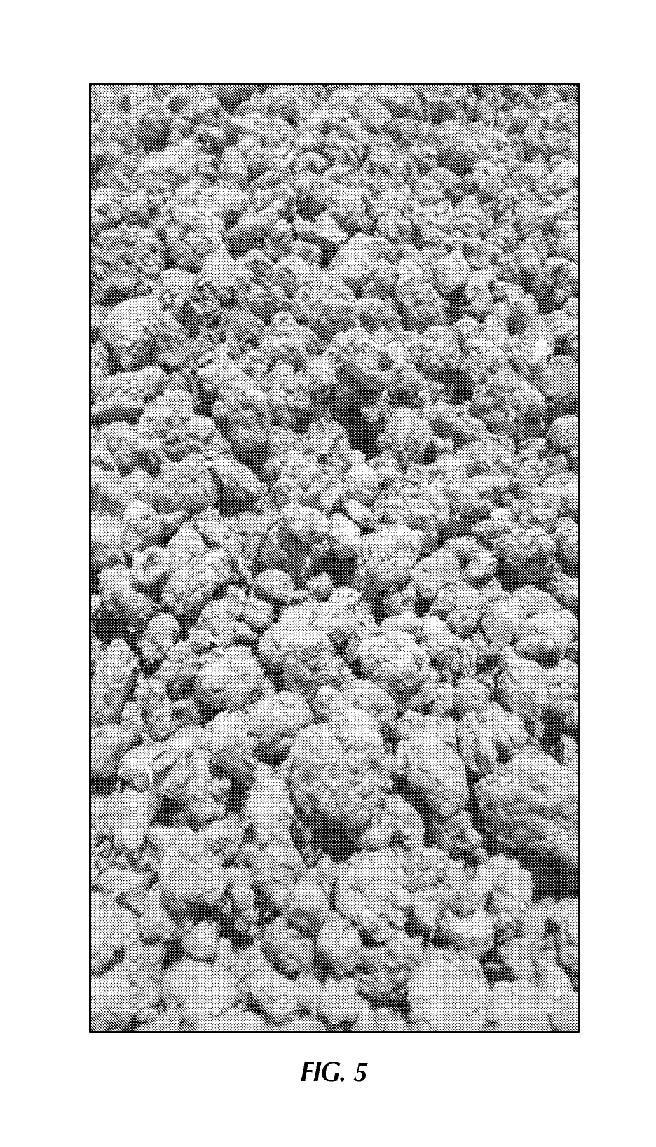

FIG. 5 is a micrograph photograph of the lightweight aggregate output from this process that can be combined with concrete for building materials.

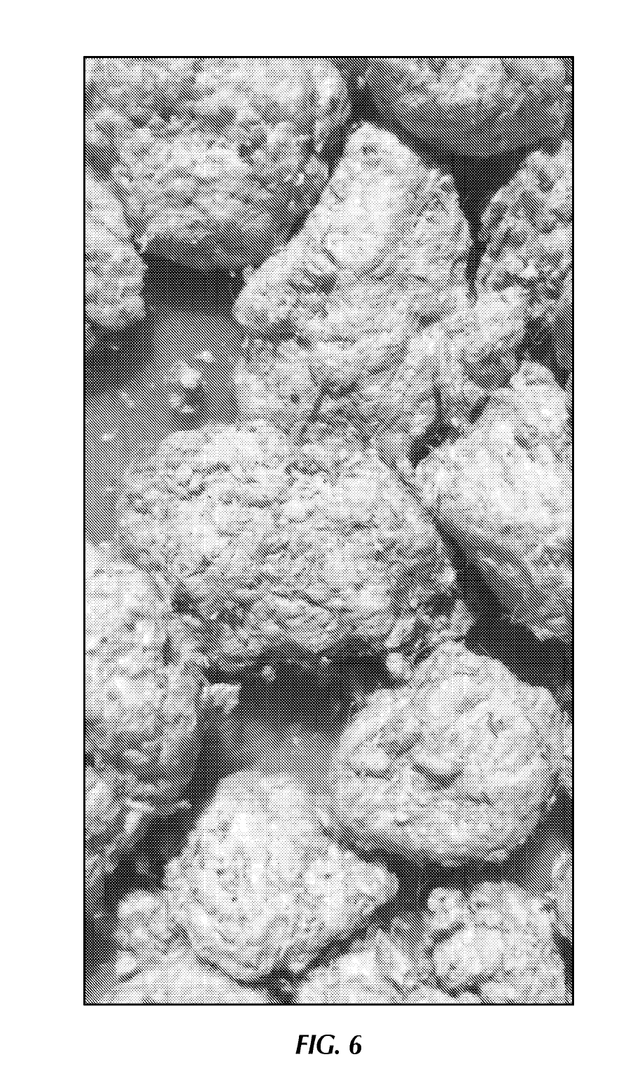

FIG. 6 is a higher-powered micrograph photograph of the lightweight aggregate output from this process that can be combined with concrete for building materials.

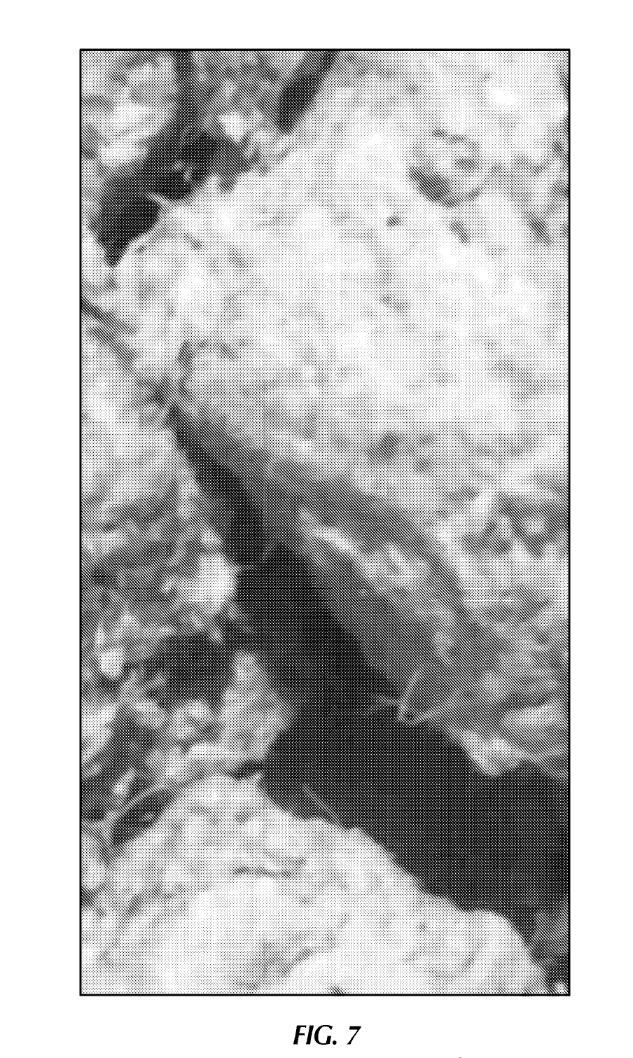

FIG. 7 is a further higher-powered micrograph photograph of the lightweight aggregate output from this process that can be combined with concrete for building materials.

### DETAILED DESCRIPTION OF A PREFERRED EMBODIMENT

FIG. 1 discloses a schematic view of the heating conveyor of the present embodiment 10 showing the deposition on a continuous basis of sludge from a paper mill 20 onto a continuous belt 15 which takes the deposited water and sludge component 22 through a sodium silicate powder dispensing station 30B before the watery sludge is moved into the first section of the dryer 40 which is heated by natural gas from an adjacent natural gas heater 43 and distributed to the heating chamber by plenums 41 from below the slowly moving conveyor belt 15. Alternatively, a sodium silicate solution dispensing station 30A could be applied to the dried sludge at the end of the drying process. The combined reaction of the sodium silicate within the initial heating chamber 40 commences the drying process on the wet sludge. Additional heating occurs in a second portion of the heating chamber 50 bringing the sludge and subjecting it to a superheated steam bath which desiccates the sludge 22 further to a point where the sludge leaves the second stage heater and is collected in a bin 60. Continuous belt 15 circles back to begin the continuous movement of sludge 22 to bin 60. As will be described in FIGS. 3 and 4, this conveyor belt system 15 can be composed of a plurality of conveyor belts sitting one above the other.

Conveyor belt 15 is semi-permeable allowing steam and heat to contact the sludge 22 carried on the belt throughout its movement through the steam enclosures 40, 50. Hot gases are collected from the top of the superheated steam portion of the conveyor zone 50 and re-circulated through the lower heated conveyor portion 40 to more efficiently dry the sludge 22. Excess superheated steam is collected from the hot zone 50 through vent 51 and condensed.

The speed of the conveyor belt 15 and the amount of heat introduced into the heaters 40 and 50 is adjusted to obtain a desired terminal moisture content of the sludge entering collecting bin 60. The speed of the conveyor 15 is adjusted by speeding up drive for the rollers 16; and the heat generated is adjusted by increasing the flame by adjusting gas valve 45 to the natural gas heater 43 adjacent the enclosed conveyor system 10.

The entirety of the operation can be controlled either manually or by sensors located at the end of the conveyor system 10 to determine the amount of moisture in the emerging sludge fibers after partial drying.

FIG. 2 is an side schematic view of the conveyor system 10 of the preferred embodiment indicating the initial drying by hot air plenum 41 and recirculation of heated air and stem from the second heat zone 50 which is distributed through plenum 41 and blowers 25 located between the rollers 16 and the top of the conveyor belt 15. It is believed that these drying zones of heating significantly aid in the generation of superheated steam in the second zone 50 thereby assisting in the rapid drying needed to match the significant feedstock rate of 12-15 tons per hour from most paper mills.

The conveyor belt should be approximately 150-200 ft. long, allowing the first heating compartment 40 to provide residence for the slowly moving sludge traveling about 1 ft. per minute for about 20-33% of the total time of the treatment. Variation to the travel and residence time, along with the applied heat, can be made to accommodate the output of the paper mill (which is expected to be between 12 and 15 tons per hour). Additional design considerations could increase the width of the conveyor belt and the desired ending moisture content. For example, as shown in FIG. 3, each of the conveyor belts 15, 15′, 15″ could be tiered to increase the amount of residence time of the sludge within the enclosed dryer system. Once the paper mill sludge reaches Zone A of conveyor 15, it is dropped to conveyor 15′ which is moving in an opposite direction and, at its end, deposits the remaining paper mill sludge onto conveyor 15″. Conveyor 15″ deposits the dried paper mill sludge into bin 60. Alternative sources of heat, other than natural gas, could be adapted to supply the superheated steam necessary to accomplish the drying of the paper mill sludge described herein, including without limitation microwave energy, or steam cogeneration from adjacent boilers.

As shown in FIG. 3, the simple schematic of FIGS. 1 and 2 may be embodied in a tiered conveyor belt drying system whereby the wet sludge is deposited on the top conveyor belt and heated until at the Zone A in the first conveyor shown, the moisture content is boiling off the sludge which recirculates the moisture and reheats this vapor until it reaches superheated steam temperatures. This superheated steam is re-circulated to each of the conveyor belts to continue drying the sludge material 22 and driving off more of the resident moisture in the sludge. FIG. 4 is a cross-sectional view of the three-tiered conveyor belt system showing the plenum 41 and the heater/blower configurations 43 that drive the superheated steam 33 throughout the drying system. Each of the conveyors 15, 15′, 15″, have superheated steam 33 directed toward the paper mill sludge material 22.

The variety of sodium silicate used in this process is a hydrous sodium silicate powder permitting acceleration of the dissolution into the sludge. The addition of hydrous sodium silicate reduces the porosity in the sludge alone because of its reaction with the calcium carbonate in the sludge. The reduction in porosity in turn reduces surface area making the end product a less-absorbent material. This result reduces the use of excess water when the lightweight aggregate is finally combined in a concrete mix; if too much water is absorbed by a lightweight aggregate it will lessen the cement's ability to hydrate properly. Most lightweight aggregates used in concrete mixes are typically pre-wet. The hydrous sodium silicate also acts as a hardener improving the strength and specific gravity of the wet sludge having high clay content. Another unexpected benefit from this particular hydrous sodium silicate treatment is the prevention of mold, fungus, and mildew occurring in the end product. Sludge treated with hydrous sodium silicate showed no visible signs and no odor. The physical characteristics of the hydrous sodium silicate used in the present process is:

| | |
|---|---|
| Ph: | approx. 12.3 |
| Wt Ratio SiO2:Na2O ± 0.1 - | 2.40 |
| Wt % Na2O ± 0.7 - | 23.8 |
| Wt % SiO2 ± 1.0 - | 57.2 |
| Wt % H2O ± 1.5 - | 17.5 |
| Density: | 38 lb/ft³ (.061 g/cm³) |
| Particle Size, Tyler: | 89% thru 100 mesh |

The application of the sodium silicate 30B in FIG. 1 begins the dehydration process of the sludge 22 since the sodium silicate starts immediately turning to a gel utilizing the moisture from the sludge 22. As noted, sufficient coverage of the deposited sludge also diminishes, if not eliminates, mold growth on the treated product. It is believed that the application of liquid sodium silicate applied to the dried sludge material can provide similar results without clumping of the powdered form. Applicant has therefore provided both forms of application in the present embodiment. The provision of a powdered form 30B at the beginning of the process can provide an alternative application form if the liquid dispensing system 30A fails.

### Description of Sludge

With a moisture content of about 50%, the solid sludge has a weight per cubic foot of 45-48 lbs. The sludge (coming from a mostly recycled fiber content) is considered “a high ash” sludge, compared to a “low ash” sludge derived from mostly virgin fiber. The contents of the desired sludge would be about 50% H₂O (water) and about 50% mechanically de-watered solids. A further breakdown of the solids content would be 50-70% organic content and 30-50% ash. The organic content consists of short fiber cellulose, calcium carbonate, and clay. The average cellulose fiber length is 1.1 mm with a specific gravity of about 2.0.

### Ash Content

As previously noted, ash content is the amount of filler in a paper feedstock. Paper consists of organic cellulose fibers combined with inorganic fillers such as clay, titanium dioxide, or calcium carbonate, added during papermaking to increase such paper properties as brightness, whiteness, or opacity. For many printing processes, a filler or ash content of 15-20%. To determine the ash content of a paper, a sample is weighed, then subjected to complete combustion (usually at 925° C., ±25° C.). This removes all the organic constituents of the sample, leaving behind a residue of inorganic materials, or fillers. This is weighed, and the percentage of the original sample that remains is its ash content. All recycled paper contains a residual ash content.

### Desired Elemental Compounds of the Material

A number of constituent materials are also found in paper mill sludge having a beneficial use within lightweight materials. These include:

Calcium Carbonate

Calcium Oxide

Aluminum Oxide

Magnesium Oxide

Iron Oxide

Silicon Dioxide

These compounds assist in the formation of strong, lasting building materials and are deemed adjuvants to concrete added to the aggregates formed from these materials.

### Drying for Beneficial Use

The nature of this invention would be to treat and further dry the material using high pressure steam for 90-240 minutes at temperatures between 150° C. (302° F.) to 300° C. (572° F.). Temperatures in this ranges creates a sterile environment and kills bacteria and mold spores that would otherwise cause the material to breakdown. Once the material is collected from the paper mill, the material can be treated with a powdered sodium silicate 30B to encapsulate the heavy metals (iron, zinc, mercury, etc.), improve the density of the dried material, reduce the absorption, as well as further improving the flame retardant qualities. Ideally, this collection process is tied directly into the paper mill's solid waste discharge point. The powdered sodium silicate could be applied at a rate of 3-10% of the weight of the RSF and spun in a rotating drum (not shown in this view) to disperse evenly. The material would then travel to a conveyor belt 15 that uses superheated steam for 150-240 minutes at temperatures between 150° C. (302° F.) to 300° C. (572° F.) The steam is generated from containing the moisture released from the RSF once heated. The duration of time can vary based on the intended use of the dried sludge. If for immediate use in pre-cast concrete applications, the ending moisture content should be 6-12%. If the output is to be stored for later use or transport, a moisture content much closer to 0% (zero) is desirable. The weight per cubic foot after drying will be 33-40 lbs. Applicant believes the heat required to generate drying of the wet paper mill sludge is significantly less than the heat expenditure in other related technologies. Moreover, no additional ash content is added to the mixture unlike other prior art attempts at using paper mill waste product as a feedstock for the manufacture of a useful lightweight aggregate.

### Specific Gravity/Moisture Absorption/Sieve Analysis

Samples of the product manufactured by this process have been tested indicating that the sample received from Applicant provided 0.0% weight of moisture as received, provided an absorption of 182.5% sample mass after saturation by water and drying at 100° C. for 24 hours, then reweighed. Density after saturation and drying for two tests was 1.56 and 1.53 g/cm³. This Surface Saturated Dry (SSD) data collected falls in the acceptable range for lightweight aggregate.

### Sieve Analysis

The sieve analysis of these samples indicates the following results:

⅜″ less than 1%

#4 2.2%

#8 27.4%

#16 27.4%

#30 31.25%

#50 10.4%

#100 1.1%

Pan less than 1%

This leads to the conclusion the sample provides a Fineness Modulus of 3.64, and is described as a very clean material.

Additional testing consisted of packing a 0.087 cubic foot container with the output material from the described process, which was weighed at 3.60 lbs. Since this container represented 1/10^{th} of a cubic foot suggesting the lightweight aggregate equaled 36.47 lbs/ft³ providing a specific gravity calculated as follows. Specific gravity equals density/62.4, or 36.47 lbs./62.4, or the equivalent of approximately 0.58 specific gravity. These results suggest this material would be an ideal lightweight aggregate for use in building materials. After drying, the lightweight aggregate is shown in the photomicrographs in FIGS. 5-7.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for fabrication of lightweight aggregate comprises the steps of:
collecting a wet sludge stream from a paper mill containing about 50% water and 50% solid sludge materials;
depositing the wet sludge stream conveying organic solids of short fiber cellulose, calcium carbonate, ash, and one or more of the following oxides—calcium oxide, aluminum oxide, magnesium oxide, iron oxide, and silicon dioxide into a drying means;
introducing sufficient heat into the drying means to create a super-heated steam from the 50% moisture content contained in the wet sludge stream; and,
removing the solids when a selected end moisture content has been obtained.

2. The method of claim 1 wherein the drying means is one or more enclosed conveying belts.

3. The method of claim 1 wherein the drying means is a rotating drum dryer.

4. The method of claim 1 wherein the drying means is a fluid bed dryer.

5. The method of claim 1 further comprises the step of spraying a coating of sodium silicate solution (40-60% water, 40-60% dried sodium silicate powder and a viscosity in the range of 180-700 centipoise) onto the dried sludge.

6. The method of claim 5 wherein the spraying of the sodium silicate solution is done in a rotating drum dryer.

7. The method of claim 5 wherein the spraying of the sodium silicate solution is done in a fluid bed dryer.

8. The method of claim 1 further comprises adding a coating of dried sodium silicate into the wet sludge beginning a reaction with the available moisture to decrease the moisture content.

9. The method of claim 8 wherein the powdered sodium silicate is applied at a rate of between 3-10% of the weight of the solids contained in the wet sludge stream.

10. The method of claim 1 wherein the heat applied to create the super heated steam is applied and re-circulated through the sludge material for a period of time between 150-240 minutes at a temperature between 150° C. (302° F.) and 300° C. (572° F.) to achieve a selected end moisture content.

11. The method of claim 1 wherein the short fiber cellulose has a fiber length of about 1.1 mm and a specific gravity of about 2.0 as carried in the wet sludge containing the cellulose fibers, calcium carbonate, clays, and ash.

12. The method of claim 1 were the selected end moisture of the light weight aggregate ranges from 5-25%.

13. The method of claim 1 wherein the lightweight aggregate has a selected end moisture content of 5-15% to be used in pre-cast concrete.

14. The method of claim 1 wherein the lightweight aggregate formed has a sieve size range resulting 99.75% of the material falling between 9.75 mm (⅜ inch) and 0.149 mm (0.0059 inch).

15. The method of claim 1 were the lightweight aggregate formed has a selected end moisture content of 12-25% to be extruded, noodled through a dye, and sheared to create a consistent size material.

16. The method of claim 15 wherein the extruded, noodled, and sheared material is further dried to achieve a moisture content of 5-15% moisture.

17. The method of claim 15 wherein the lightweight aggregate is used a replacement of traditional aggregates in a range of 5-50%.

18. A lightweight aggregate comprising:
a dried paper mill waste stream initially comprising about 50% water by weight and 50% solid waste product having a mix of organic solids of short fiber cellulose, calcium carbonate, ash, and one or more of the following oxides—calcium oxide, aluminum oxide, magnesium oxide, iron oxide, and silicon dioxide; and,
hydrous sodium silicate.

19. The lightweight aggregate of claim 18 wherein the hydrous sodium silicate is between 3-10% of the weight of the solids.

20. The lightweight aggregate of claim 15 wherein the short fiber cellulose has a fiber length of about 1.1 mm and a specific gravity of about 2.0 as carried in the wet sludge containing the cellulose fibers, calcium carbonate, clays, and ash.

21. The lightweight aggregate of claim 15 dried to an end moisture of 5-15%, useable as an aggregate in pre-cast concrete in replacement of traditional sand or gravel in a range of between 5-50% by weight.

22. The lightweight aggregate of claim 15 dried to an end moisture of between 12-15% to be extruded, noodled through a dye, and sheared to create a consistent sized aggregate material.

23. The lightweight aggregate of claim 19 wherein the consistent sized lightweight aggregate is further dried to a selected end moisture content of between 5-15%.

24. The lightweight aggregate of claim 20 wherein the dried lightweight aggregate is combined with sand and cement in an amount of between 5-50% by weight.
